(19) United States
(12) Patent Application Publication
(10) Pub. No.: US 2025/0130036 A1
(43) Pub. Date: Apr. 24, 2025

(54) IMAGE SENSING SYSTEM AND METHOD THEREOF

(71) Applicant: TAIWAN SEMICONDUCTOR MANUFACTURING COMPANY, LTD., Hsinchu (TW)

(72) Inventors: Hung-Yi TU, Hsinchu City (TW); Meng-Hsiu WU, Hsinchu (TW); Shang-Fu YEH, Hsinchu City (TW); Chiao-Yi HUANG, Hsinchu County (TW); Calvin Yi-Ping CHAO, Hsinchu County (TW)

(73) Assignee: TAIWAN SEMICONDUCTOR MANUFACTURING COMPANY, LTD., Hsinchu (TW)

(21) Appl. No.: 18/492,033

(22) Filed: Oct. 23, 2023

(51) Int. Cl. G01B 11/02; G01J 3/02; G01J 3/10; G01J 3/12; G01J 3/14; G01J 3/28

(52) U.S. Cl. CPC G01B 11/026; G01J 3/0262; G01J 3/0275; G01J 3/108; G01J 3/14; G01J 3/2803; G01J 2003/1213

(57) ABSTRACT

A method includes generating light pulses by an illumination source toward an object; collecting the light pulses reflected from the object by an image sensor; generating a first signal-time plot of a sensor signal by the image sensor; generating a second signal-time plot of an index signal, wherein the second signal-time plot of the index signal comprises pulsed signals corresponding to the light pulses, respectively; collecting data from selected time periods of the first signal-time plot of the sensor signal, wherein the selected time periods of the first signal-time plot of the sensor signal are the same as time periods of the light pulses in the second signal-time plot of the index signal; and generating a third signal-time plot of an output signal based on the collected data.

### BACKGROUND

Integrated circuit (IC) technologies are constantly being improved. Such improvements frequently involve scaling down device geometries to achieve lower fabrication costs, higher device integration density, higher speeds, and better performance. Along with the advantages realized from reducing geometry size, improvements are being made directly to the IC devices. One such IC device is an image sensor device. An image sensor device includes a pixel array (or grid) for detecting light and recording an intensity (brightness) of the detected light. The pixel array responds to the light by accumulating a charge—for example, the higher the intensity of the light, the higher the charge accumulated in the pixel array. The accumulated charge is then used (for example, by other circuitry) to provide a color and brightness for use in a suitable application, such as a digital camera.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a top view of an image sensor device in accordance with some embodiments of the present disclosure.

FIG. 2 illustrates a schematic view of an image sensing system in accordance with some embodiments of the present disclosure.

FIG. 3 illustrates a block diagram of generating an image in accordance with some embodiments of the present disclosure.

FIG. 4 illustrates signal versus time plots in accordance with some embodiments of the present disclosure.

FIG. 5 illustrates signal versus time plots in accordance with some embodiments of the present disclosure.

FIG. 6 illustrates a schematic view of an image sensing system in accordance with some embodiments of the present disclosure.

FIG. 7 illustrates signal versus time plots in accordance with some embodiments of the present disclosure.

FIG. 8 is a method of an image sensing system in accordance with some embodiments of the present disclosure.

FIG. 9 illustrates signal versus time plots in accordance with some embodiments of the present disclosure.

FIG. 10 is a method of an image sensing system in accordance with some embodiments of the present disclosure.

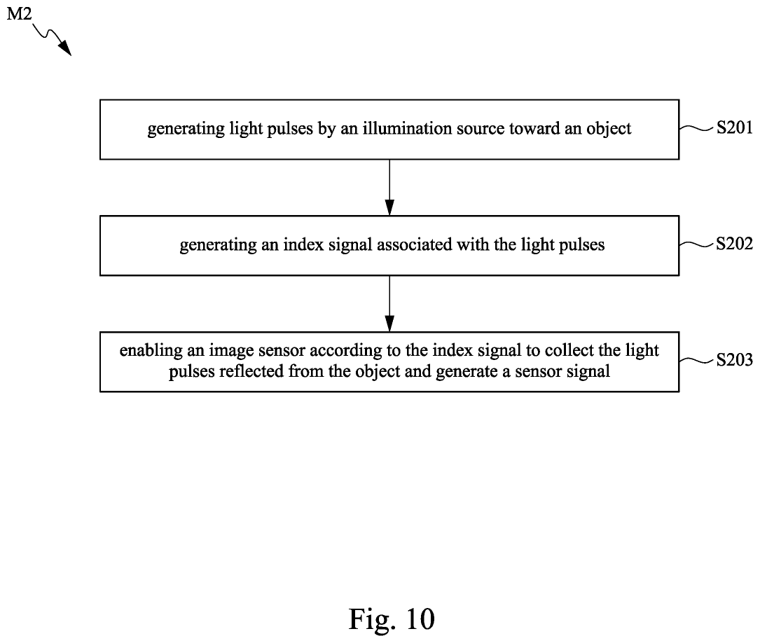

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. As used herein, “around,” “about,” “approximately,” or “substantially” may generally mean within 20 percent, or within 10 percent, or within 5 percent of a given value or range. Numerical quantities given herein are approximate, meaning that the term “around,” “about,” “approximately,” or “substantially” can be inferred if not expressly stated. One skilled in the art will realize, however, that the values or ranges recited throughout the description are merely examples, and may be reduced or varied with the down-scaling of the integrated circuits.

Solid-state imaging devices with higher resolution are used in many commercial applications especially camera and also for other light imaging uses. Such imaging devices typically comprise of CCD (charge coupled device) photo detector arrays with associated switching elements, and address (scan) and read out (data) lines. This CCD technology is matured so much that now days millions of pixels and surrounding circuitry can be fabricated using the CMOS (complementary metal oxide semiconductor) technology. As today's CCD technology is based on silicon (Si)-technology, the detectable spectral ranges of CCD are limited to the wavelengths below 1 μm where Si exhibits absorption. Besides, CCD based imaging technique has also other shortcomings such as high efficiency response combined with high quantum efficiency over broad spectral ranges. This broad spectral detection is required in many applications. One of them is the free space laser communication where shorter (in visible ranges) and near infrared wavelengths is expected to be used.

Short-wave infrared (SWIR) detectors (e.g., photodiode or sensor pixel) especially have been studied extensively over the last decade for its application in optical communication. These photodiodes are for near infrared detection, especially the wavelength vicinity to 1000 and 2500 nm, where today's optical communication is dealt with. Present short-wave infrared (SWIR) image sensor usually suffers serious dark currents. Thus, minimizing the dark current would be desirable to improve the overall performance.

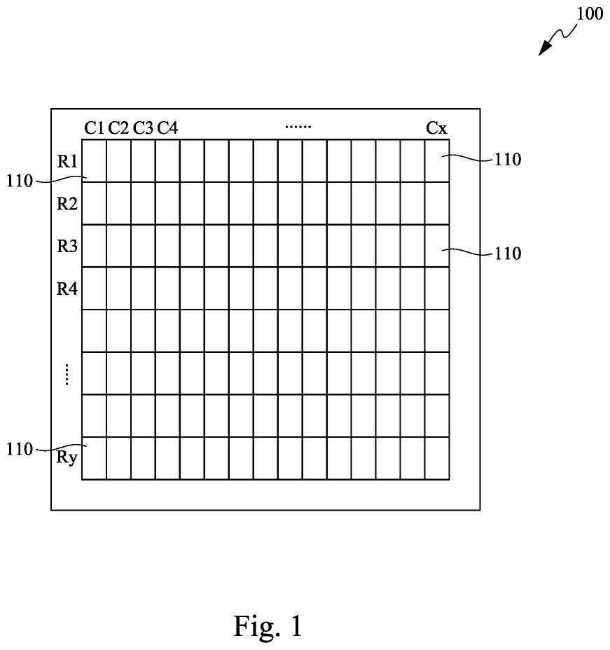

FIG. 1 is a top view of an image sensor device in accordance with some embodiments of the present disclosure. The image sensor device 100 may include an array of pixels 110. Each pixel 110 is arranged into a column (for example, Cl to Cx) and a row (for example, RI to Ry). The term “pixel” refers to a unit cell containing features (for example, a photodetector and various circuitry, which may include various semiconductor devices) for converting electromagnetic radiation to an electrical signal.

The pixels 110 may include photodiodes, complementary metal-oxide-semiconductor (CMOS) image sensors, charged coupling device (CCD) sensors, active sensors, passive sensors, other sensors, or combinations thereof. The pixels 110 may be designed as having various sensor types. For example, one group of pixels 110 may be CMOS image sensors and another group of pixels 110 may be passive sensors. In some embodiments, each pixel 110 is an active pixel sensor, such as a complementary metal-oxide-semiconductor (CMOS) image sensor. In some embodiments, each pixel 110 may include a photodetector, such as a photogate-type photodetector, for recording an intensity or brightness of light (radiation). Each pixel 110 may also include various semiconductor devices, such as various transistors including a transfer transistor, a reset transistor, a source-follower transistor, a select transistor, other suitable transistor, or combinations thereof. Additional circuitry, an input, and/or an output may be coupled to the pixel array to provide an operation environment for the pixels 110 and support external communications with the pixels 110. For example, the pixel array may be coupled with a readout circuitry and/or a control circuitry.

The image sensor may of each pixel 110 may be an integrated circuit device. In some embodiments, the integrated circuit device may include a backside illuminated (BSI) image sensor device. The integrated circuit device may be an integrated circuit (IC) chip, system on chip (SoC), or portion thereof, that includes various passive and active microelectronic components, such as resistors, capacitors, inductors, diodes, metal-oxide-semiconductor field effect transistors (MOSFETs), complementary MOS (CMOS) transistors, bipolar junction transistors (BJTs), laterally diffused MOS (LDMOS) transistors, high power MOS transistors, fin-like field effect transistors (FinFETs), other suitable components, or combinations thereof.

The integrated circuit device may include a substrate. In some embodiments, the substrate is a semiconductor substrate including silicon. Alternatively or additionally, the substrate may include another elementary semiconductor, such as germanium and/or diamond; a compound semiconductor including silicon carbide, gallium arsenic, gallium phosphide, indium phosphide, indium arsenide, and/or indium antimonide; an alloy semiconductor including SiGe, GaAsP, AlInAs, AlGaAs, GalnAs, GaInP, and/or GaInAsP; or combinations thereof.

The substrate may include isolation features, such as local oxidation of silicon (LOCOS) and/or shallow trench isolation (STI), to separate (or isolate) various regions and/or devices formed on or within the substrate. For example, the isolation features isolate one sensor element from adjacent sensor elements. That is, the isolation features may define the boundary between adjacent two sensor elements.

As noted above, the integrated circuit device includes the sensor element (or light-sensing element). The sensor element detects an intensity (brightness) of radiation, such as incident radiation (light). The sensor element may be configured to correspond to a specific light wavelength. In other words, the sensor element may be configured to detect an intensity (brightness) of a particular wavelength of light. In some embodiments, each sensor element corresponds to a pixel, such as the pixel 110 illustrated in FIG. 1. In some embodiments, the sensor element includes a photodetector, such as a photodiode, that includes a light-sensing region (or photo-sensing region).

The sensor element may be a short-wave infrared (SWIR) sensor element. For example, the sensor element is sensitive to a radiation having wavelength in a range from about 1000 nm to about 2500 nm. In other embodiments, the sensor element is sensitive to a radiation having wavelength in a range from about 1000 nm to about 1500 nm. In some embodiments, the SWIR sensor element may include InGaAs or Ge.

The sensor element further includes various transistors. The light-sensing region and various transistors (which can collectively be referred to as pixel circuitry) allow the sensor element to detect the intensity of the particular light wavelength. Additional circuitry, inputs, and/or outputs may be provided for the sensor element to provide an operation environment for the sensor element and/or support communication with the sensor element.

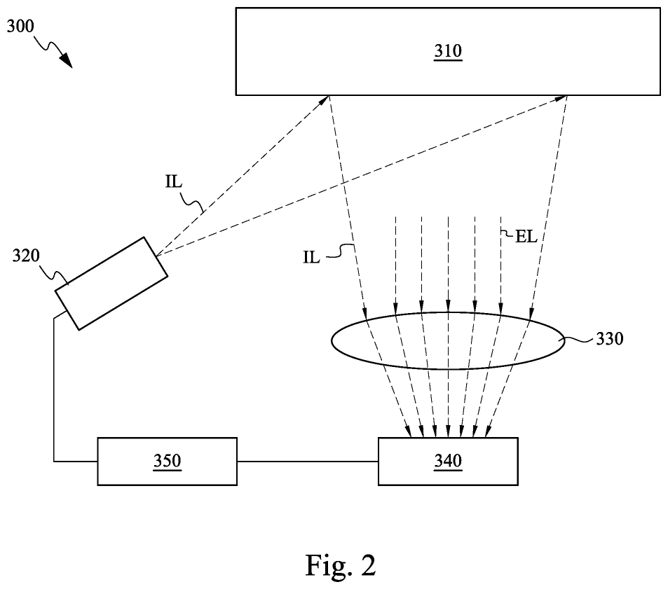

FIG. 2 is a schematic view of an image sensing system in accordance with some embodiments of the present disclosure. Shown there is an image sensing system 300. In some embodiments, the image sensing system 300 is a short-wave infrared (SWIR) image sensing system. The image sensing system 300 may utilize illumination with at least one wavelength in a SWIR spectral range, in accordance with one or more embodiments of the present disclosure. In greater detail, the image sensing system 300 is configured to provide an optical metrology measurement of an object 310.

Here, the term “image” refers to a digital representation of a scene detected by the imaging system, which stores a color value for each picture element (pixel) in the image, each pixel color representing light arriving to the imaging system from the object 310. It is noted that optionally, the imaging system may be further operative to generate other representations of object 310 (e.g., a depths map, 3D model, polygon mesh), but the term “image” refers to two-dimensional (2D) image with no depth data.

Here, term “object” refers to any object in the field of view (FOV) of the imaging sensor, such as solids, liquid, flexible, and rigid objects. Some non-limiting examples of such objects include people, vehicles, roads, animals, plants, buildings, electronics, clouds, microscopic samples, items during manufacturing, and so on.

The image sensing system 300 include at least one illumination source 320, in which the illumination source 320 is configured to generate an illumination IL toward the object 310. In some embodiments, the illumination IL generated by the illumination source 320 is short-wave infrared (SWIR) where the wavelength of the SWIR is in a range from about 1000 nm to about 2500 nm.

The image sensing system 300 further includes at least one objective lens 330, which collects the illumination IL reflected from the object 310 and directs the reflected illumination IL towards an image sensor 340. More specifically, the lens 330 may be in various positional arrangements with respect to the image sensor 340, such that the lens 330 focuses the illumination IL on the light sensing element(s) of the image sensor 340. The lens 330 includes suitable material, and may have a variety of shapes and sizes depending on an index of refraction of the material used for the lens and/or a distance between the lens 330 and image sensor 340.

The image sensor 340 collects the illumination IL reflected from the object 310 and generates data or information based on the collected illumination IL. The image sensor 340 may include elements of the image sensor device 100 as described with respect to FIG. 1. The data or information generated by the image sensor 340 is transmitted to a data computing system 350. The data computing system 350 determines image/profile of the object 310. In some embodiments, the image sensor 340 is a SWIR image sensor sensitive to at least some SWIR wavelengths. In some embodiments, the SWIR image sensor is an Indium gallium arsenide (InGaAs) image sensor. In other embodiments, the SWIR image sensor is a germanium (Ge) image sensor. Here, the data computing system 350 may include a computer processor or a set of computer processors that are programmed by a computer program to perform several operations, which will be discussed later. In some embodiments, the image sensor 340 and the illumination source 320 may be integrated in a device.

Generally, the SWIR image sensor may suffer from severe dark current (dark noise) compared to an image sensor with silicon-based light sensing element. Here, the “dark current” may be referred to a current that flows (for example produces a signal) even if no light (e.g., illumination IL) is hitting the image sensor 340. In some embodiments, the dark current of the SWIR image sensor may be caused by non-ideal generation-recombination current and/or thermal excitation of electrons in the InGaAs/Ge light-sensing element. This is because InGaAs and Ge include smaller bandgap than silicon. As a result, the dark current (dark noise) may be “printed” on the image of the object 310 generated by the image sensing system 300, and will affect the image quality of the object 310.

On the other hand, environment light EL (environment noise) may also affect image quality of the object 310. Here, the “environment light” may be referred to the light that originates from surface reflectance variation, light scattering on the object surface, ambient illumination variation, or the like. Similarly, the environment light EL (environment noise) may also be “printed” on the image of the object 310 generated by the image sensing system 300, and will affect the image quality of the object 310.

Embodiments of the present disclosure provide methods to minimize the dark current and the environment light EL. In greater detail, a method is performed to screen out the dark current (dark noise) and/or the environment light EL (environment noise), so as to improve the image quality generated by the image sensing system 300. As a result, the generated image can properly reflect the profile of the object 310.

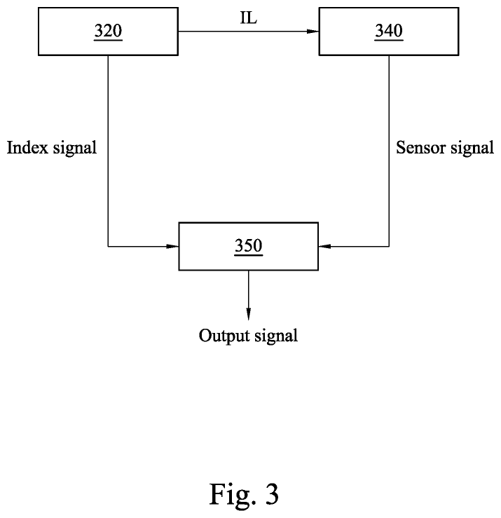

FIG. 3 is a block diagram of generating an image in accordance with some embodiments of the present disclosure. It is noted that the elements of FIG. 3 are similar to those described with respect to FIG. 2, such elements are labeled the same, and relevant details will not be repeated for brevity.

Shown there are the illumination source 320, the image sensor 340, and the data computing system 350. The illumination source 320 is configured to generate an illumination IL. As discussed above with respect to FIG. 2, the illumination IL is directed toward an object 310, and the reflected illumination IL is collected by the image sensor 340. In some embodiments, the illumination source 320 is configured to periodically generating short-wave infrared (SWIR) pulses toward the object 310. Stated another way, the illumination source 320 is configured to generating SWIR pulses with fixed frequency. In some embodiments, two adjacent SWIR pulses include a non-zero time duration therebetween.

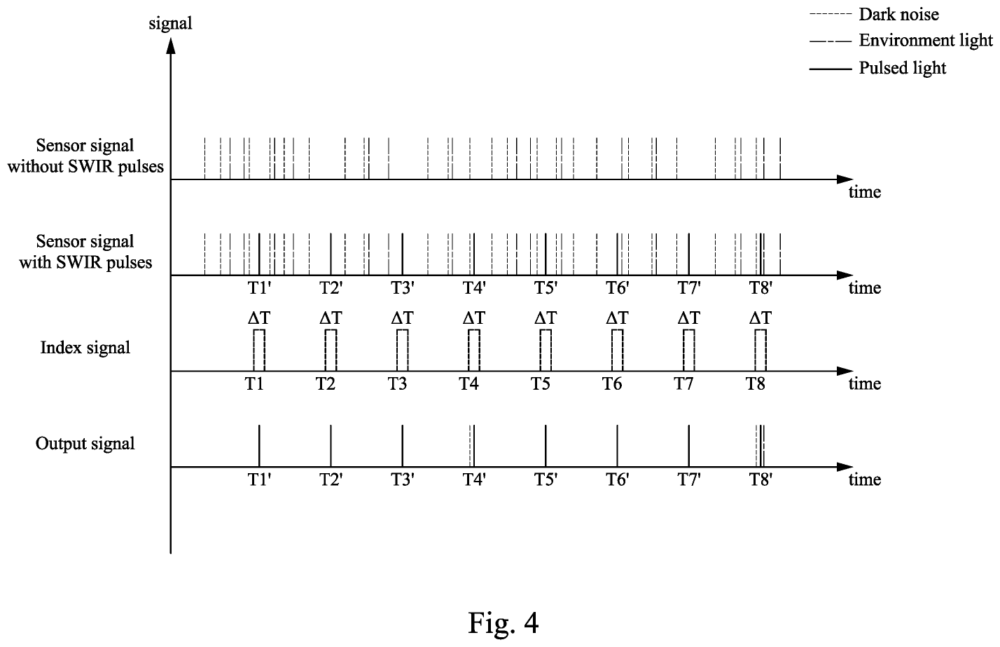

During generating the illumination IL, the illumination source 320 generates an index signal associated with the illumination IL. In greater detail, the index signal includes information associated with the illumination IL. For example, if the illumination IL includes the periodical SWIR pulses as discussed above, the index signal may include pulsed signals synchronized with the periodical SWIR pulses. For example, the pulsed signals of the pulsed signals may include the timing of as the SWIR pulses, and the same frequency as the SWIR pulses, which will be discussed in more detail in FIG. 4.

On the other hand, the image sensor 340 is configured to generate a sensor signal. For example, as mentioned above, the image sensor 340 may receive the illumination IL reflected from the object 310, and then generate a sensor signal which includes information of the periodical SWIR pulses reflected by the object 310. In some embodiments, aside from the periodical SWIR pulses that reflect the image/profile of the object 310, the sensor signal may also include different types of noises, such as dark noise or environment noise as discussed above.

The index signal generated by the illumination source 320 and the sensor signal generated by the image sensor 340 are transferred to the data computing system 350. Stated another way, the data computing system 350 may receive the index signal and the sensor signal. The data computing system 350 is configured to generate an output signal based on the index signal and the sensor signal. In brief, the data computing system 350 is configured to screen out the noises (e.g., dark noise or environment light) in the sensor signal by using the index signal, so as to generate a substantial pure signal that properly reflects the image/profile of the object 310, which will be discussed in more detail in FIG. 4.

FIG. 4 illustrates signal versus time plots in accordance with some embodiments of the present disclosure. In greater detail, FIG. 4 shows signal versus time plots of the sensor signal, the index signal, and the output signal as discussed above, respectively.

FIG. 4 shows the sensor signals generated by the image sensor 340 without and with the periodical SWIR pulses. In the situation of the sensor signal without the periodical SWIR pulses, the illumination source 320 does not generate any illumination. In such situation, the image sensor 340 may generate a signal-time plot only including dark noise signals and environment light signals. On the other hand, in the situation of the sensor signal with the periodical SWIR pulses, the illumination source 320 periodically generates the SWIR pulses. In such situation, the image sensor 340 may generate a signal-time plot including the SWIR pulsed light signals (e.g., reflected by the object 310), dark noise signals, and environment light signals. In greater detail, the signal-time plot of the sensor signal includes the SWIR pulsed light signals at time points T1′, T2′, T3′, T4′, T5′. T6′. T7′, and T8′. In some embodiments, the time duration (e.g., pulse width) of each SWIR pulse generated by the image sensor 340 is in a range from about 500 to about 1000 ps (picosecond). Similarly, the time duration (e.g., pulse width) of each SWIR pulsed light signals generated by the image sensor 340 is in a range from about 500 to about 1000 ps (picosecond). In the depicted embodiments, the frequency of the SWIR pulses (SWIR pulsed light signals) is lower than average frequency of the dark noise signals, while the disclosure is not limited thereto.

FIG. 4 also shows the index signal generated from the illumination source 320. The index signal includes pulsed signals that correspond to the periodical SWIR pulses generated by the illumination source 320. The index signal includes pulsed signals at time points T1, T2, T3, T4, T5, T6, T7, T8. In the index signal, each pulsed signal has a time duration ΔT (e.g., pulse width). In some embodiments, the time duration ΔT is proportional to a distance between the illumination source 320 and the object 310. If the distance between the illumination source 320 and the object 310 is D, and the distance D and the time duration ΔT may satisfy the following equation: D=ΔT*1.5×10⁸ (m/s). For example, if distance D between the illumination source 320 and the object 310 is 15 cm (e.g., 0.15 m), the time duration ΔT may be 1 ns (e.g., 1×10⁻⁹ s). In some embodiments, the time duration ΔT of each pulsed signal in the index signal is longer than the time duration of each SWIR pulse, this will be beneficial to collect correct data, which will be discussed later.

The data computing system 350 may receive the signal-time plots of the sensor signal and the index signal once the illumination source 320 starts to generate the periodical SWIR pulses. However, in real situation, the data computing system 350 cannot distinguish the SWIR pulsed light signals from the dark noise signals and the environment light signals just based on the signal-time plot of the sensor signal. Accordingly, the index signal is used as a reference for assisting the data computing system 350 to find the correct time points where the SWIR pulsed light signals occur.

Once the data computing system 350 receive the signal-time plots of the sensor signal and the index signal, the data computing system 350 synchronizes the signal-time plot of the sensor signal with the signal-time plot of the index signal. That is, the time line of the signal-time plot of the sensor signal is synchronized with the time line of the signal-time plot of the index signal.

Afterwards, the data computing system 350 collects data from selected time periods of the signal-time plot of the sensor signal according to the signal-time plot of the index signal. In greater detail, the selected time periods of the signal-time plot of the sensor signal are the same as the time periods of the pulsed signals in the signal-time plot of the index signal. For example, according to the pulsed signal at time point T1 in the signal-time plot of the index signal, the data computing system 350 collects data from the signal-time plot of the sensor signal at time point T1 for a duration ΔT. Similarly, according to the pulsed signals at time points T2-T8 in the signal-time plot of the index signal, the data computing system 350 collects data from the signal-time plot of the sensor signal at time points T2-T8 for a duration ΔT, respectively. On the other hands, the data outside the selected time periods of the signal-time plot of the sensor signal will be discarded. In particular, the dark noise signals and the environment light signals outside the selected time periods of the signal-time plot of the sensor signal will be discarded. Afterwards, the data computing system 350 outputs the collected data as an output signal.

Based on the above discussion, it can be seen that the data computing system 350 collects data from selected time periods of the signal-time plot of the sensor signal according to the signal-time plot of the index signal. The data computing system 350 not only generate an output signal including the SWIR pulsed light signals, but also screen out the unwanted dark noise signals and the environment light signals. Accordingly, the output signal may be a substantial pure signal that reflects the image/profile of the object 310.

It is understood that, although the above discussed method can screen out the dark noise signals and the environment light signals, the method may not completely screen out all of the dark noise signals and the environment light signals in some embodiments. For example, when a dark noise signal or an environment light signal occurs at a time point that is within the selected time periods of the signal-time plot of the sensor signal, the dark noise signal or the environment light signal may also be considered as an “effective data”, and will be collected by the data computing system 350 and will be output as the output signal. As shown in the signal-time plot of the output signal, it can be seen that at time point T4′, a dark noise signal is collected and output by the data computing system 350. Similarly, at time point T6′, an environment light signal is collected and output by the data computing system 350. Similarly, at time point T8′, a dark noise signal and an environment light signal are collected and output by the data computing system 350. Although some of the dark noise signals and the environment light signals may be output, majority of the dark noise signals and the environment light signals may be screed out during the method discussed, and thus the output image quality can still be improved.

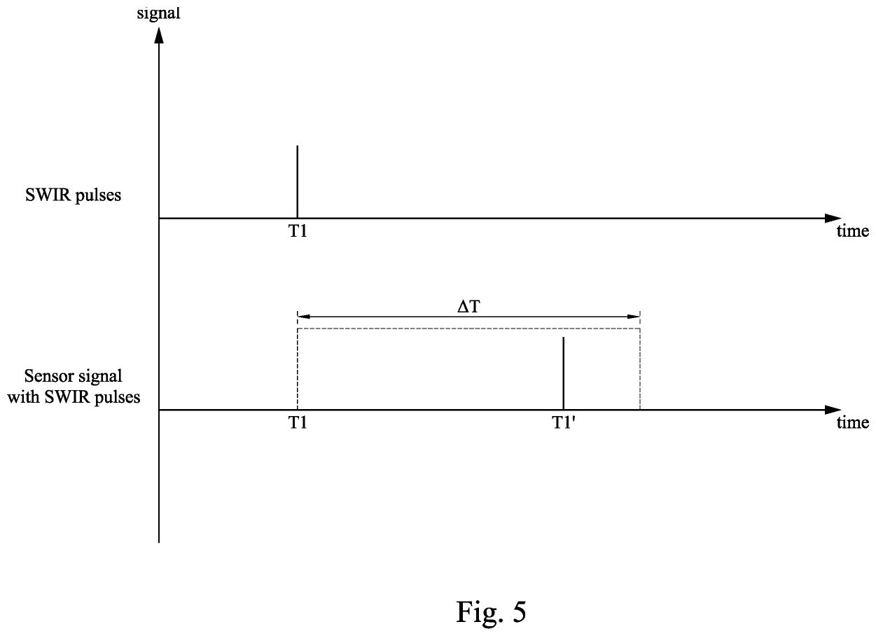

FIG. 5 illustrates signal versus time plots in accordance with some embodiments of the present disclosure. In greater detail, FIG. 5 illustrates a principle how the data computing system 350 collects data from the signal-time plot of the sensor signal.

In FIG. 5, shown there are a signal-time plot of a SWIR pulse generated by the illumination source 320 and a signal-time plot of a sensor signal generated by the image sensor 340. For example, in the signal-time plot of the SWIR pulse, a SWIR pulse is generated from the illumination source 320 at time point T1. On the other hand, in the signal-time plot of the sensor signal, there is a SWIR pulsed light signal corresponding to the SWIR pulse. That is, the SWIR pulse is incident on the object 310 and the reflected SWIR pulse is collected by the image sensor 340 and output as the SWIR pulsed light signal in the signal-time plot of the sensor signal. However, it can be seen that the SWIR pulsed light signal occurs at time point T1′ that is slightly later than the time point T1. This is because the propagation of SWIR pulse may cause a time delay between the generation of the SWIR pulse and the generation of the SWIR pulsed light signal. Referring back to FIG. 4, similarly, the SWIR pulsed light signal occurs at time points T2′-T8′ are also slightly later than the time points T2-T8 where the SWIR pulses are generated.

To address the above issue, each pulsed signal of the index signal may include a time duration ΔT (pulse time). The time duration ΔT may ensure that the SWIR pulsed light signal occurs at time point T1′ will be collected by the data computing system 350. As mentioned above, the time duration ΔT is proportional to the distance between the illumination source 320 and the object 310. That is, when the distance D between the illumination source 320 and the object 310 increases, the time duration ΔT may increase accordingly. As a result, the increased time duration ΔT may be sufficient to cover the delayed time point T1′ as a result of the increased distance D.

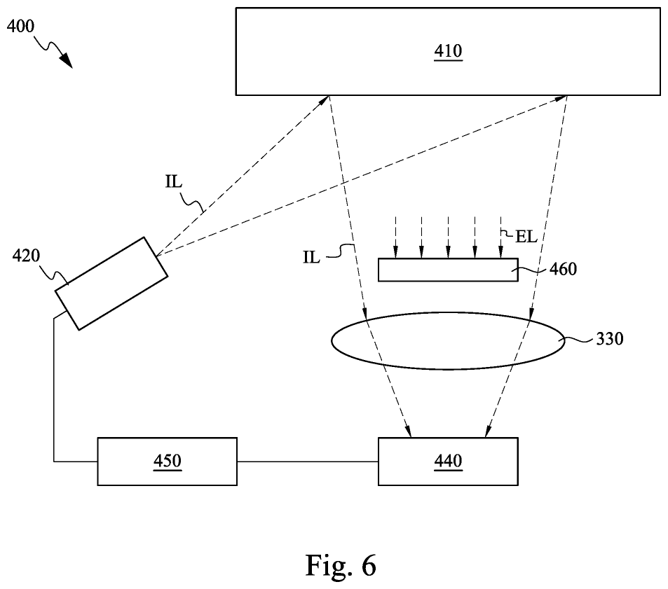

FIG. 6 illustrates a schematic view of an image sensing system in accordance with some embodiments of the present disclosure. Shown there is an image sensing system 400. In some embodiments, the image sensing system 400 is a short-wave infrared (SWIR) image sensing system. The image sensing system 400 may utilize illumination with at least one wavelength in a SWIR spectral range, in accordance with one or more embodiments of the present disclosure. In greater detail, the image sensing system 400 is configured to provide an optical metrology measurement of an object 410.

The image sensing system 400 include at least one illumination source 420, in which the illumination source 420 is configured to generate an illumination IL toward the object 410. In some embodiments, the illumination IL generated by the illumination source 420 is short-wave infrared (SWIR) where the wavelength of the SWIR is in a range from about 1000 nm to about 2500 nm.

The image sensing system 400 further includes at least one objective lens 430, which collects the illumination IL reflected from the object 410 and directs the reflected illumination IL towards an image sensor 440. More specifically, the lens 430 may be in various positional arrangements with respect to the image sensor 440, such that the lens 430 focuses the illumination IL on the light sensing element(s) of the image sensor 440. The lens 430 includes suitable material, and may have a variety of shapes and sizes depending on an index of refraction of the material used for the lens and/or a distance between the lens 430 and image sensor 440.

The image sensor 440 collects the illumination IL reflected from the object 410 and generates data or information based on the collected illumination IL. The image sensor 440 may include elements of the image sensor device 100 as described with respect to FIG. 1. The data or information generated by the image sensor 440 is transmitted to a data computing system 450. The data computing system 450 determines image/profile of the object 410. In some embodiments, the image sensor 440 is a SWIR image sensor sensitive to at least some SWIR wavelengths. In some embodiments, the SWIR image sensor is an Indium gallium arsenide (InGaAs) image sensor. In other embodiments, the SWIR image sensor is a germanium (Ge) image sensor. Here, the data computing system 450 may include a computer processor or a set of computer processors that are programmed by a computer program to perform several operations, which will be discussed later. In some embodiments, the image sensor 340 and the illumination source 420 may be integrated in a device.

The image sensing system 400 further includes a bandpass filter 460 that permits a narrow band of wavelengths centered on or around a desired central wavelength to pass through the filter while rejecting other wavelengths. In some embodiments, the bandpass filter 460 may permit radiation having wavelength that is the same as the wavelengths of the illumination IL to pass through. That is, the illumination IL reflected from the object may pass through the bandpass filter 460 and will be collected by the image sensor 440. However, the environment light EL may be screened out by the bandpass filter 460, and may not be received by the image sensor 440.

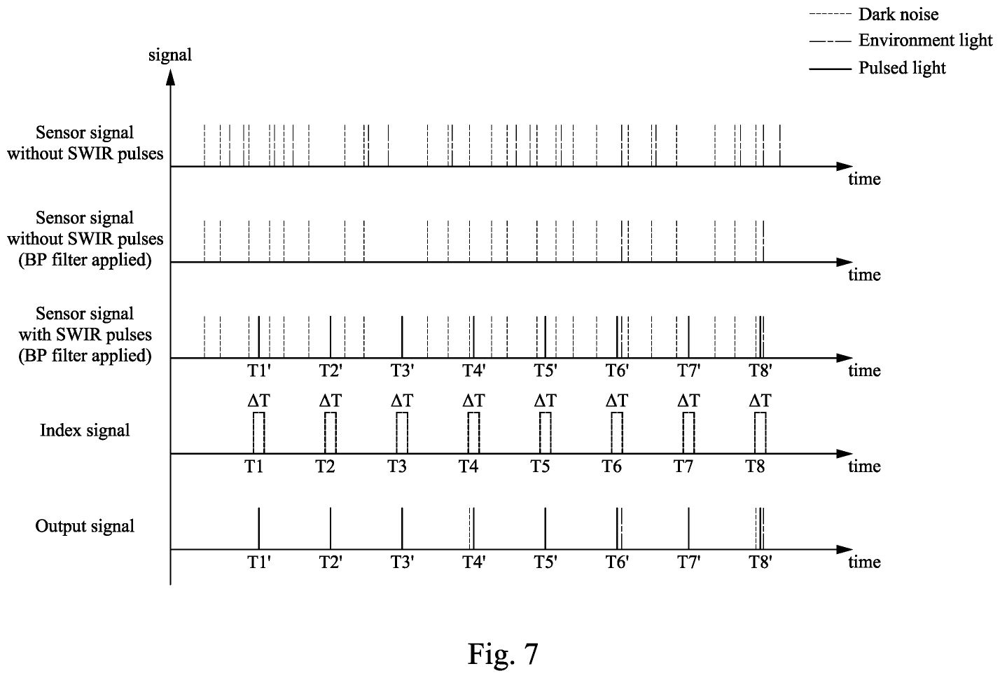

FIG. 7 illustrates signal versus time plots in accordance with some embodiments of the present disclosure. In greater detail, FIG. 7 shows signal versus time plots of the sensor signal, the index signal, and the output signal as discussed above, respectively.

FIG. 7 shows the sensor signal generated by the image sensor 440 without the periodical SWIR pulses. In such situation, the illumination source 320 does not generate any illumination, and thus the image sensor 440 may generate a signal-time plot only including dark noise signals and environment light signals.

FIG. 7 shows the sensor signal generated by the image sensor 440 without the periodical SWIR pulses, and the bandpass filter 460 is applied in the image sensing system 400. In such situation, the environment light EL may be rejected by the bandpass filter 460, and may not be received by the image sensor 440. As a result, in the signal-time plot, most of the environment light signals are screed out. However, it can be seen that still some environment light signals appear in the signal-time plot. This is because some environment lights EL that have wavelengths similar to the wavelength of the SWIR pulses may still pass through the bandpass filter 460.

FIG. 7 shows the sensor signal generated by the image sensor 440 with the periodical SWIR pulses, and the bandpass filter 460 is applied in the image sensing system 400. In such situation, the image sensor 440 may generate a signal-time plot including the SWIR pulsed light signals (e.g., reflected by the object 410), dark noise signals, and few environment light signals (e.g., most environment lights EL have been screened out by the bandpass filter 460). In greater detail, the signal-time plot of the sensor signal includes the SWIR pulsed light signals at time points T1′, T2′, T3′, T4′, T5′. T6′. T7′, and T8′. In some embodiments, the time duration (e.g., pulse width) of each SWIR pulse generated by the image sensor 440 is in a range from about 500 to about 1000 ps (picosecond). Similarly, the time duration (e.g., pulse width) of each SWIR pulsed light signals generated by the image sensor 440 is in a range from about 500 to about 1000 ps (picosecond).

FIG. 7 also shows the index signal generated from the illumination source 420. The index signal includes pulsed signals that correspond to the periodical SWIR pulses generated by the illumination source 420. The index signal includes pulsed signals at time point T1, T2, T3, T4, T5, T6, T7, T8. In the index signal, each pulsed signal has a time duration ΔT (e.g., pulse width). In some embodiments, the time duration ΔT is proportional to a distance between the illumination source 420 and the object 410. If the distance between the illumination source 420 and the object 410 is D, and the distance D and the time duration ΔT may satisfy the following equation: D=ΔT*1.5×10⁸ (m/s). For example, if distance D between the illumination source 320 and the object 410 is 15 cm (e.g., 0.15 m), the time duration ΔT may be 1 ns (e.g., 1×10⁻⁹ s). In some embodiments, the time duration ΔT of each pulsed signal in the index signal is longer than the time duration of each SWIR pulse, this will be beneficial to collect correct data.

The data computing system 450 may receive the signal-time plots of the sensor signal and the index signal once the illumination source 420 starts to generate the periodical SWIR pulses. However, in real situation, the data computing system 450 cannot distinguish the SWIR pulsed light signals from the dark noise signals and the environment light signals just based on the signal-time plot of the sensor signal. Accordingly, the index signal is used as a reference for assisting the data computing system 450 to find the correct time points where the SWIR pulsed light signals occur.

Once the data computing system 450 receive the signal-time plots of the sensor signal and the index signal, the data computing system 450 synchronizes the signal-time plot of the sensor signal with the signal-time plot of the index signal. That is, the time line of the signal-time plot of the sensor signal is synchronized with the time line of the signal-time plot of the index signal.

Afterwards, the data computing system 450 collects data from selected time periods of the signal-time plot of the sensor signal according to the signal-time plot of the index signal. In greater detail, the selected time periods of the signal-time plot of the sensor signal are the same as the time periods of the pulsed signals in the signal-time plot of the index signal. For example, according to the pulsed signal at time point T1 in the signal-time plot of the index signal, the data computing system 450 collects data from the signal-time plot of the sensor signal at time point T1 for a duration ΔT. Similarly, according to the pulsed signals at time points T2-T8 in the signal-time plot of the index signal, the data computing system 450 collects data from the signal-time plot of the sensor signal at time points T2-T8 for a duration ΔT, respectively. On the other hands, the data outside the selected time periods of the signal-time plot of the sensor signal will be discarded. In particular, the dark noise signals and the environment light signals outside the selected time periods of the signal-time plot of the sensor signal will be discarded. Afterwards, the data computing system 450 outputs the collected data as an output signal.

Based on the above discussion, it can be seen that the data computing system 450 collects data from selected time periods of the signal-time plot of the sensor signal according to the signal-time plot of the index signal. The data computing system 450 not only generate an output signal including the SWIR pulsed light signals, but also screen out the unwanted dark noise signals and the environment light signals. Accordingly, the output signal may be a substantial pure signal that reflects the image/profile of the object 410.

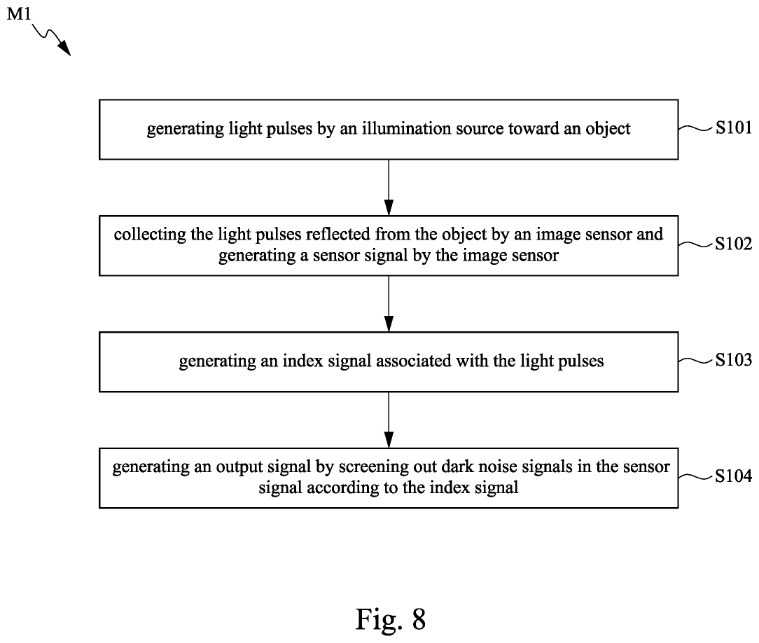

FIG. 8 is a method of an image sensing system in accordance with some embodiments of the present disclosure. Although the method M1 described in FIG. 8 is illustrated and/or described as a series of acts or events, it will be appreciated that the method is not limited to the illustrated ordering or acts. Thus, in some embodiments, the acts may be carried out in different orders than illustrated, and/or may be carried out concurrently. Further, in some embodiments, the illustrated acts or events may be subdivided into multiple acts or events, which may be carried out at separate times or concurrently with other acts or sub-acts. In some embodiments, some illustrated acts or events may be omitted, and other un-illustrated acts or events may be included.

The method M1 starts at block S101, generating light pulses by an illumination source toward an object. In some embodiments, the illumination source can be the illumination source 320/420 as discussed above, and the object can be the object 310/410 as discussed above.

The method M1 proceeds to block S102, collecting the light pulses reflected from the object by an image sensor and generating a sensor signal by the image sensor. In some embodiments, the image sensor can be the image sensor 340/440 as discussed above.

The method M1 proceeds to block S103, generating an index signal associated with the light pulses. In some embodiments, generating the index signal can be performed using the illumination source 320/420 as discussed above.

The method M1 proceeds to block S104, generating an output signal by screening out dark noise signals in the sensor signal according to the index signal. In some embodiments, generating the output signal can be performed using the data computing system 350/450 as discussed above.

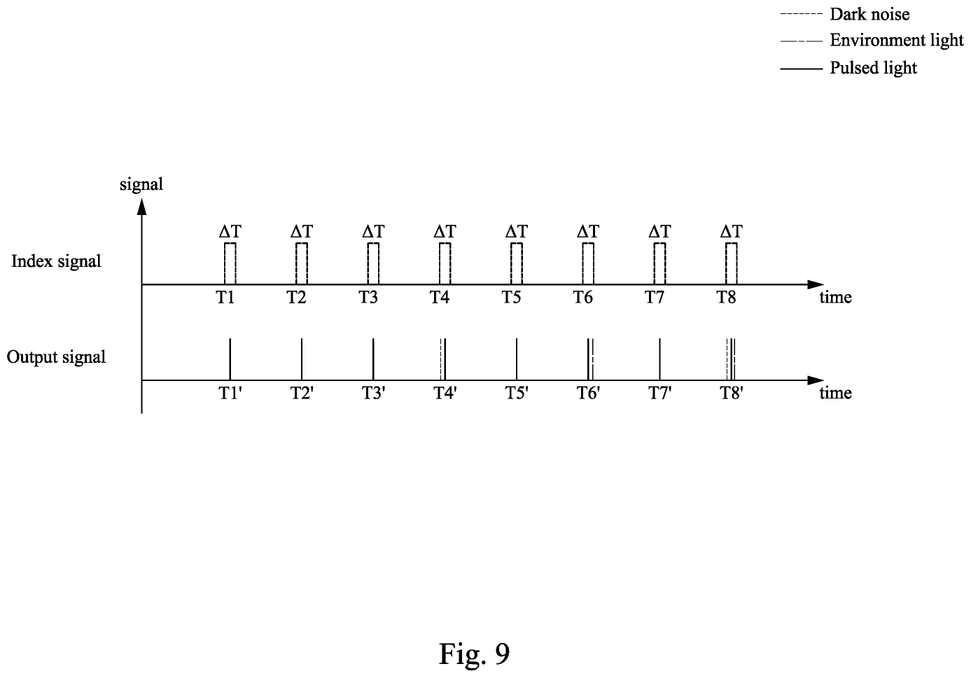

FIG. 9 illustrates signal versus time plots in accordance with some embodiments of the present disclosure. In greater detail, FIG. 9 shows signal versus time plots of the index signal and the output signal as discussed above, respectively.

FIG. 9 shows the index signal generated from the illumination source 320 (or 420) as described above. In the embodiments of FIG. 9, the image sensor 340 (or 440) is enabled according to the index signal. When the illumination source 320 starts to generate the illumination IL, the image sensor 340 may receive the index signal at the same time. The image sensor 340 is enabled according to the pulsed signals of the index signal. In greater detail, the image sensor 340 is enabled during the time duration of each pulsed signal of the index signal. For example, the image sensor 340 is enabled during time T1 to T1+ΔT. T2 to T2+ΔT. T3 to T3+ΔT. T4 to T4+ΔT, T5 to T5+ΔT, T6 to T6+ΔT, T7 to T7+ΔT, and T8 to T8+ΔT. That is, in such time durations, the image sensor 340 is enabled and starts to collect the illumination IL reflected from the object 310 (or 410) and generate data or information based on the collected illumination IL. Because the SWIR pulses are generated within such time durations, the image sensor 340 would collect the SWIR pulses reflected from the object 310. On the other hand, outside these time durations, the image sensor 340 is halted, such that the image sensor 340 does not collect data the illumination IL reflected from the object 310 and does not generate data or information based on the collected illumination IL. In some embodiments, the data computing system 350 (or 450) may receive the index signal from the illumination source 320, and may control the image sensor 340 to generate output signal based on the index signal.

Based on the above discussion, it can be seen that the image sensor 340 is enabled during selected time periods according to the signal-time plot of the index signal. The data computing system 350 therefore not only generate an output signal including the SWIR pulsed light signals, but also screen out the unwanted dark noise signals and the environment light signals. Accordingly, the output signal may be a substantial pure signal that reflects the image/profile of the object 310.

FIG. 9 is a method of an image sensing system in accordance with some embodiments of the present disclosure. Shown there is a method M2. The method M2 starts at block S201, generating light pulses by an illumination source toward an object. In some embodiments, the illumination source can be the illumination source 320/420 as discussed above, and the object can be the object 310/410 as discussed above.

The method M2 proceeds to block S202, generating an index signal associated with the light pulses. In some embodiments, generating the index signal can be performed using the illumination source 320/420 as discussed above.

The method M2 proceeds to block S203, enabling an image sensor according to the index signal to collect the light pulses reflected from the object and generate a sensor signal. In some embodiments, the image sensor can be the image sensor 340/440 as discussed above.

Based on the above discussions, it can be seen that the present disclosure offers advantages. It is understood, however, that other embodiments may offer additional advantages, and not all advantages are necessarily disclosed herein, and that no particular advantage is required for all embodiments. Embodiments of the present disclosure provide a method for generating an image of an object. An illumination source generates light pulses toward the object. An image sensor collects the light pulses reflected from the object and generating a sensor signal by the image sensor. An index signal is generated associated with the light pulses. An output signal is generated by screening out dark noise signals in the sensor signal according to the index signal. On advantage of the embodiments is that the dark noise signals are screened out from the sensor signal according to the index signal, and thus the image quality of the image sensing system can be improved. Another advantage of the embodiments is that pulsed light is less power consumption than continuous light. Yet another advantage of the embodiments is that SWIR wavelength light source is much safer to human eyes. Yet another advantage of the embodiments is that the method can be conducted under room temperature, without special calibration operation.

In some embodiments of the present disclosure, a method includes generating light pulses by an illumination source toward an object; collecting the light pulses reflected from the object by an image sensor; generating a first signal-time plot of a sensor signal by the image sensor; generating a second signal-time plot of an index signal, wherein the second signal-time plot of the index signal comprises pulsed signals corresponding to the light pulses, respectively; collecting data from selected time periods of the first signal-time plot of the sensor signal, wherein the selected time periods of the first signal-time plot of the sensor signal are the same as time periods of the light pulses in the second signal-time plot of the index signal; and generating a third signal-time plot of an output signal based on the collected data.

In some embodiments, the light pulses are short-wave infrared (SWIR) pulses.

In some embodiments, a wavelength of the SWIR pulses is in a range from about 1000 nm to about 2500 nm.

In some embodiments, the image sensor comprises light-sensing element made of Ge or InGaAs.

In some embodiments, collecting data from selected time periods of the first signal-time plot of the sensor signal is performed such that dark noise signals outside the selected time periods of the first signal-time plot of the sensor signal are discarded.

In some embodiments, the light pulses and the pulsed signals comprise a same frequency.

In some embodiments, a pulse width of each of the light pulses is less than a pulse width of each of the pulsed signals.

In some embodiments, the pulse width of each of the pulsed signals is proportional to a distance between the illumination source and the object.

In some embodiments of the present disclosure, a method includes generating short-wave infrared (SWIR) pulses by an illumination source toward an object; generating a signal-time plot of an index signal, wherein the signal-time plot of the index signal comprises pulsed signals, wherein a time duration of each of the pulsed signals is proportional to a distance between the illumination source and the object; and enabling an image sensor according to the pulsed signals of the index signal, so as to collect the SWIR pulses reflected from the object by the image sensor.

In some embodiments, the image sensor comprises light-sensing element made of Ge or InGaAs.

In some embodiments, the method further includes screening out environment lights using a bandpass filter, such that the environment lights are not collected by the image sensor, wherein the bandpass filter permits a radiation having a wavelength that is the same as a wavelength of the SWIR pulses to pass through.

In some embodiments, the time duration of each of the pulsed signals is ΔT, the distance between the illumination source and the object is D, and wherein ΔT and D satisfy D=ΔT*1.5×10⁸ (m/s).

In some embodiments, a time duration of each of the SWIR pulses is less than the time duration of each of the pulsed signals.

In some embodiments, the SWIR pulses and the pulsed signals comprise a same frequency.

In some embodiments, the image sensor is enabled during selected time periods, wherein the selected time periods are the same as time periods of the SWIR signals in the signal-time plot of the index signal.

In some embodiments of the present disclosure, an image sensing system includes a short-wave infrared (SWIR) source configured to generate SWIR pulses toward an object and generate an index signal associated with the SWIR pulses. An image sensor is configured to receive the SWIR pulses reflected from the object and generate a sensor signal based on the SWIR pulses. A data computing system is configured to screen out dark noise signals in the sensor signal according to the index signal.

In some embodiments, the index signal comprises a signal-time plot having pulsed signals synchronized with the SWIR pulses, and a time duration of each of the pulsed signals is proportional to a distance between the SWIR source and the object.

In some embodiments, the time duration of each of the pulsed signals is ΔT, the distance between the SWIR source and the object is D, and wherein ΔT and D satisfy D=ΔT*1.5×10⁸ (m/s).

In some embodiments, the image sensing system further includes a bandpass filter between the object and the image sensor.

In some embodiments, the image sensor comprises light-sensing element made of Ge or InGaAs.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
generating light pulses by an illumination source toward an object;
collecting the light pulses reflected from the object by an image sensor;
generating a first signal-time plot of a sensor signal by the image sensor;
generating a second signal-time plot of an index signal, wherein the second signal-time plot of the index signal comprises pulsed signals corresponding to the light pulses, respectively;
collecting data from selected time periods of the first signal-time plot of the sensor signal, wherein the selected time periods of the first signal-time plot of the sensor signal are the same as time periods of the light pulses in the second signal-time plot of the index signal; and
generating a third signal-time plot of an output signal based on the collected data.

2. The method of claim 1, wherein the light pulses are short-wave infrared (SWIR) pulses.

3. The method of claim 2, wherein a wavelength of the SWIR pulses is in a range from about 1000 nm to about 2500 nm.

4. The method of claim 2, wherein the image sensor comprises light-sensing element made of Ge or InGaAs.

5. The method of claim 1, wherein collecting data from selected time periods of the first signal-time plot of the sensor signal is performed such that dark noise signals outside the selected time periods of the first signal-time plot of the sensor signal are discarded.

6. The method of claim 1, wherein the light pulses and the pulsed signals comprise a same frequency.

7. The method of claim 1, wherein a pulse width of each of the light pulses is less than a pulse width of each of the pulsed signals.

8. The method of claim 7, wherein the pulse width of each of the pulsed signals is proportional to a distance between the illumination source and the object.

9. A method, comprising:
generating short-wave infrared (SWIR) pulses by an illumination source toward an object;
generating a signal-time plot of an index signal, wherein the signal-time plot of the index signal comprises pulsed signals, wherein a time duration of each of the pulsed signals is proportional to a distance between the illumination source and the object; and
enabling an image sensor according to the pulsed signals of the index signal, so as to collect the SWIR pulses reflected from the object by the image sensor.

10. The method of claim 9, wherein the image sensor comprises light-sensing element made of Ge or InGaAs.

11. The method of claim 9, further comprising screening out environment lights using a bandpass filter, such that the environment lights are not collected by the image sensor, wherein the bandpass filter permits a radiation having a wavelength that is the same as a wavelength of the SWIR pulses to pass through.

12. The method of claim 9, wherein the time duration of each of the pulsed signals is ΔT, the distance between the illumination source and the object is D, and wherein ΔT and D satisfy D=ΔT*1.5×10⁸ (m/s).

13. The method of claim 9, wherein a time duration of each of the SWIR pulses is less than the time duration of each of the pulsed signals.

14. The method of claim 9, wherein the SWIR pulses and the pulsed signals comprise a same frequency.

15. The method of claim 9, wherein the image sensor is enabled during selected time periods, wherein the selected time periods are the same as time periods of the pulsed signals in the signal-time plot of the index signal.

16. An image sensing system, comprising:
a short-wave infrared (SWIR) source configured to generate SWIR pulses toward an object and generate an index signal associated with the SWIR pulses;
an image sensor configured to receive the SWIR pulses reflected from the object and generate a sensor signal based on the SWIR pulses; and
a data computing system configured to screen out dark noise signals in the sensor signal according to the index signal.

17. The image sensing system of claim 16, wherein the index signal comprises a signal-time plot having pulsed signals synchronized with the SWIR pulses, and a time duration of each of the pulsed signals is proportional to a distance between the SWIR source and the object.

18. The image sensing system of claim 17, wherein the time duration of each of the pulsed signals is ΔT, the distance between the SWIR source and the object is D, and wherein ΔT and D satisfy D=ΔT*1.5×10⁸ (m/s).

19. The image sensing system of claim 16, further comprises a bandpass filter between the object and the image sensor.

20. The image sensing system of claim 16, wherein the image sensor comprises light-sensing element made of Ge or InGaAs.
